(19) United States
(12) Patent Application Publication
(10) Pub. No.: US 2007/0120975 A1
(43) Pub. Date: May 31, 2007

(54) Karaoke television device, karaoke television and a method for mixing voices

(75) Inventors: Wen-Wei Tsai, Taipei (TW); Hung-Yuan Li, Taipei (TW); Show-Nan Chung, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/585,133

(22) Filed: Oct. 24, 2006

(30) Foreign Application Priority Data
Oct. 28, 2005 (TW) 94136934

(51) Int. Cl. H04N 7/18; H04N 9/47

(52) U.S. Cl. 348/61

(57) ABSTRACT

A karaoke TV device is disclosed, which includes: an audio/video generating circuit which generates and outputs a TV video signal and a TV audio signal; a voice receiving circuit which receives an external voice signal; and a voice processing circuit which is electrically coupled to the audio/video generating circuit and the voice receiving circuit, receives, analyzes the TV audio signal and the external voice signal, mixes and softens the TV audio signal and the external voice, so as to output a mixed audio signal. Therefore, at the time when user watches TV, voice of the user can be mixed into the voice of the program.

### BACKGROUND OF THE INVENTION

(1) Field of the Invention

The invention relates to a television, and more particularly, to a karaoke television device, television and a method for mixing voices, which can mix voice of a user into voice of programs, when the user watches television.

(2) Description of the Prior Art

The lives of Modern people are busy and nervous, and sometimes need entertainments to express their emotions, so as to relieve pressures and burdens of daily lives. However, the major entertainment that modern people take is to sing songs in karaoke pub. However, singing songs in karaoke pub is very expensive, and the karaoke pub is crowded with people, so that it is not very easy to make a reservation of seats at random.

Therefore, homes of some people are equipped with karaoke audio/video system. However, because songs to be played by the karaoke audio/video system are usually stored into compact discs or memories, unless users keep buying new compact discs or memories, users cannot sing the newest songs. Moreover, when watching television (TV), if there is a song on TV, which a user want to sing with to output or to add sound effect into a TV program, although the user may add his voice, the adding may make the voice inconsistent, which results in the fact that the voice of the user cannot be mixed into background music.

### SUMMARY OF THE INVENTION

It is an object of the present invention to provide a karaoke television device which can mix voice of a user into voice of a program, when watching TV.

To achieve above objects, the karaoke television device of the present invention includes an audio/video signal generating circuit, a voice receiving circuit and a voice processing circuit. The audio/video signal generating circuit generates and outputs TV video signal and TV audio signal. The voice receiving circuit receives and outputs external voice signal. The voice processing circuit receives and analyzes the TV audio signal and external voice signals, mixes and softens the TV audio signal and the external voice signals, so as to output a mixed audio signal.

In the preferred embodiment of the present invention, the voice processing circuit will divide the TV audio signal into a main audio signal and a background audio signal according to frequency. The mixing and softening processing replaces the main audio signals by the external voice signal, and mixes with the background music signals, so as to produce the mixed audio signal.

In the preferred embodiment, the present invention further includes an audio processing circuit which is electrically coupled to the voice processing circuit, receives, adjusts the mixed audio signal, and then outputs it.

In the preferred embodiment, after the voice processing circuit receives a karaoke enabling signal, the mixing and softening the external audio signal is achieved by the TV audio signal.

To achieve the objects, the TV of the present invention includes a karaoke TV device, a display device, and a voice output device. The karaoke TV device includes an audio/video signal generating circuit, a voice receiving circuit and a voice processing circuit. The audio/video signal generating circuit generates and outputs a TV video signal and a TV audio signal. The voice receiving circuit receives and outputs the external voice signal. The voice processing circuit receives, analyzes the TV audio signal and the external voice signal, mixes and softens the external voice signal according to the TV audio signal, so as to output a mixed audio signal. The display device receives and displays the TV video signal. The voice output device receives and outputs the mixed audio signal.

To achieve the objects, the method for mixing voices of the present invention is applied to a TV. The method for mixing voices includes the steps of: providing a TV audio signal; receiving an external voice signal; judging if a karaoke enabling signal is received; mixing and softening the external voice signal by the TV audio signal when it is judged that the karaoke enabling signal is received; and outputting a mixed audio signal.

In the preferred embodiment of the present invention, further including a step of adjusting and outputting the mixed audio signal.

### BRIEF DESCRIPTION OF THE DRAWINGS

The present invention will now be specified with reference to its preferred embodiment illustrated in the drawings, in which:

FIG. 1 is a circuit block diagram of TV of the present invention; and

FIG. 2 is a flowchart of the steps for mixing voices of the present invention.

### DESCRIPTION OF THE PREFERRED EMBODIMENTS

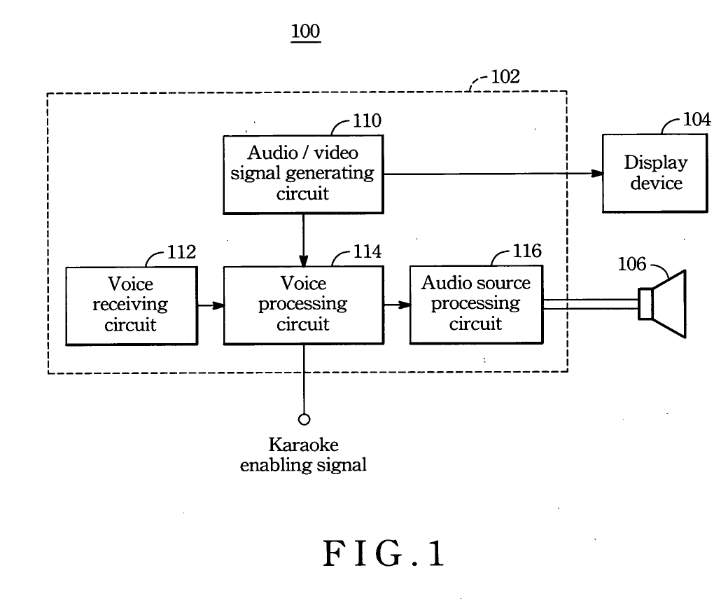

First, please refer to FIG. 1 which shows a circuit block diagram of a TV of the present invention. The TV 100 includes a karaoke TV device 102, a display device 104, and a voice output device 106. The display device 104 can be, for example, liquid crystal display (LCD), cathode ray tube (CRT), plasma display panel (PDP) etc. or other display having display function. The voice output device 106 can be a voice amplifier.

The karaoke TV device 102 includes a audio/video signal generating circuit 110, a voice receiving circuit 112, a voice processing circuit 114, and an audio source processing circuit 116. The karaoke TV device 102 is electrically coupled to the display device 104 and the voice output device 106.

The audio/video signal generating circuit 110 is electrically coupled to the display device 104 and the voice processing circuit 114, produces, and outputs a TV video signal and a TV audio signal. In the preferred embodiment, the audio/video signal generating circuit 110 can be, for example, TV signals transmitted in a cable manner or in a wireless manner by TV broadcasting companies, and generates the TV video signal and the TV audio signal after being decoded.

In the preferred embodiment of the present invention, the TV audio signal includes a main audio signal and a background music signal, both of which are divided by frequency.

The voice receiving circuit 112 is electrically coupled to the voice processing circuit 114, receives an external voice signal, and outputs it to voice processing circuit 114. The voice receiving circuit 112 can be, for example, a microphone, or any device having a function of receiving voice.

The voice processing circuit 114 can receives the TV audio signal from the audio/video signal generating circuit 110, receives the external voice signal from the voice receiving circuit 112, and mixes and softens the TV audio signal and the external voice signal, so as to get and output a mixed audio signal.

In the preferred embodiment, the mixing and softening processing is to replace the TV audio signal by the external voice signal, and mixes with the background music signal. Before replacing the main audio signal by the external audio signal, the main audio signal is first attenuated, and is mixed with the external voice signal.

In the preferred embodiment of the present invention, before mixing and softening, volume, voice frequency (high frequency or low frequency), and voice waveform is first analyzed, but not limited hereto.

The audio source processing circuit 116 is electrically coupled to the voice processing circuit 114, receives, adjusts, and outputs the mixed audio signal. As is well-known by skilled people, the adjustments includes adjusting the voice frequency, voice waveform, voice volume of the mixed audio signal, but not limited hereto.

In the embodiment, when the voice processing circuit 114 receives the karaoke enabling signal, the external voice signal is mixed and softened according to the TV audio signal. If there is no the karaoke enabling signal, no further step is taken. The generation of the karaoke enabling signal is the time when user switches on the karaoke function of the TV, or it is judged by the voice processing circuit 114 if there is the external voice signal from the voice receiving circuit 112.

The display device 104 receives a TV video signal sent from the audio/video generating circuit 110, and displays it. The voice output device 106 is electrically coupled to the audio source processing circuit 116, receives and output the mixed audio signal.

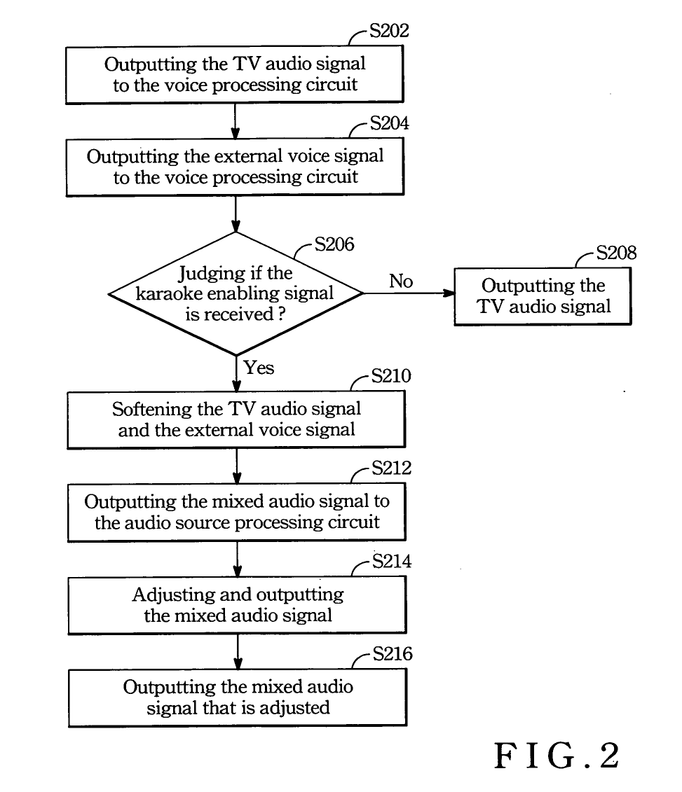

Please refer to FIG. 2 which shows flowchart of the steps of a method for mixing voices. Please refer to FIG. 1 and FIG. 2. The method for mixing voices generates the TV audio signal through the audio/video generating circuit 110, outputs the TV video signal to the display device 104 and outputs the TV audio signal to the voice processing circuit 114 (s202).

The voice receiving circuit 112 receives the external voice signal, for example, voice of user, and outputs the external voice signal to the voice processing circuit 114 (s204).

The voice processing circuit 114 judges if the karaoke enabling signal is received (s206). When the voice processing circuit judges that the voice processing circuit 114 does not receive the karaoke enabling signal, then the TV audio signal is outputted to the voice processing circuit 116, and the voice output device 106 outputs the TV audio signal (s208).

When the voice processing circuit 114 judges that the karaoke enabling signal is received, then the voice processing circuit 114 will mix and soft the TV audio signal and the external voice signal (s210). After the mixing and softening, the voice processing circuit 114 outputs the mixed audio signal to the audio source processing circuit 116 (s212).

In the preferred embodiment, the audio source processing circuit 116 adjusts and outputs the mixed audio signal (s214). The voice outputs device 106 receives and outputs the mixed audio signal that is adjusted (s216).

In the preferred embodiment, the external voice signal and the TV audio signal, which are processed by the voice processing circuit 114 can be digital signal or analog signal, but are not limited hereto. When the external voice signal and the TV audio signal are digital signal, then designer must add an analog/digital converter. Then before the voice output device 106 outputs, the external voice signal and the TV audio signal are converted into analog signal.

In the preferred embodiment of the present invention, the mixing and softening can process the external voice signal according to the voice waveform, voice frequency and voice volume of the TV audio signal, so that the voice waveform, voice frequency, and voice volume, which are outputted by the voice output device 106 are similar to the voice waveform, voice frequency, and voice volume of the TV audio signal.

The karaoke TV device, TV and method for mixing of the present invention can let user use microphone to input his voice into the TV if TV program plays a song that user want to sings with, user wants let his voice play through the TV, or user wants to add some sound effects in TV program, and the mixed voice having both user's voice and background music voice is played.

While the present invention has been particularly shown and described with reference to a preferred embodiment, it will be understood by those skilled in the art that various changes in form and detail may be without departing from the spirit and scope of the present invention.

What is claimed is:

1. A karaoke TV device, comprising:
an audio/video generating circuit which generates and outputs a TV video signal and a TV audio signal;
a voice receiving circuit which receives an external voice signal; and
a voice processing circuit which is electrically coupled to the audio/video generating circuit and the voice receiving circuit, receives, analyzes the TV audio signal and the external voice signal, mixes, and softens the TV audio signal and the external voice so as to output a mixed audio signal.

2. The device according to claim 1, wherein the voice processing circuit divides the TV audio signal into a main audio signal and a background music signal according to a frequency.

3. The device according to claim 2, wherein the mixing and softening is to replace the main audio signal by the external voice signal and mix with the background music signal, so as to generate the mixed audio signal.

4. The device according to claim 1 further comprising an audio source processing circuit which is electrically coupled to the voice processing circuit to receive, adjust, and output the mixed audio signal.

5. The device according to claim 4, wherein the adjustment includes adjusting a voice frequency of the mixed audio signal.

6. The device according to claim 4, wherein the adjustment includes adjusting a voice waveform of the mixed audio signal.

7. The device according to claim 4, wherein the adjustment includes adjusting a voice volume of the mixed audio signal.

8. The device according to claim 1, wherein after receiving a karaoke enabling signal, the voice processing circuit mixes and softens the external voice signal according to the TV audio signal.

9. The device according to claim 8, wherein when the voice processing circuit does not receive the karaoke enabling signal, the TV audio signal is outputted.

10. A TV, comprising:
a karaoke TV device which comprises an audio/video signal generating circuit which generates and outputs a TV video signal and a TV audio signal;
a voice receiving circuit which receives and outputs an external voice signal;
a voice processing circuit which is electrically coupled to the audio/video signal generating circuit and the voice receiving circuit, receives, analyzes the TV audio signal and the external voice signal, mixes and softens according to the TV audio signal and the external voice signal, so as to output a mixed audio signal;
a display device which is electrically coupled to the audio/video signal generating circuit for receiving and displaying the TV video signal; and
a voice output device which is electrically coupled to the voice processing circuit for receiving and outputting the mixed audio signal.

11. The TV according to claim 10, wherein the voice processing circuit divides the TV audio signal into a main audio signal and a background music signal according to a frequency.

12. The TV according to claim 11, wherein the mixing and softening is to replace the main audio signal by the external voice signal, and mixes with the background music signal to generate the mixed audio signal.

13. The TV according to claim 10 further comprising an audio source processing circuit which is electrically coupled between the voice processing circuit and the voice output device for receiving, adjusting, and outputting the mixed audio signal.

14. The TV according to claim 13, wherein the adjustment includes adjusting voice frequency of the mixed audio signal.

15. The TV according to claim 13, wherein the adjustment includes adjusting voice waveform of the mixed audio signal.

16. The TV according to claim 13, wherein the adjustment includes adjusting voice volume of the mixed audio signal.

17. The TV according to claim 10, wherein after receiving a karaoke enabling signal, the voice processing circuit mixes and softens the external voice signal according to the TV audio signal.

18. The TV according to claim 17, wherein when the voice processing circuit does not receive the karaoke enabling signal, the TV audio signal is outputted.

19. A method for mixing voices, which method is applied to a TV, the method comprising the steps of:
receiving a TV audio signal;
receiving an external voice signal;
receiving a karaoke enabling signal;
mixing and softening the TV audio signal and the external voice signal; and
outputting a mixed audio signal.

20. The method according to claim 19, wherein the voice processing circuit divides the TV audio signal into a main audio signal and a background music signal according to a frequency.

21. The method according to claim 20, wherein the mixing and softening is to place the main audio signal by the external voice signal and mix with the background music signal, so as to generate the mixed audio signal.

22. The method according to claim 21 further comprising the step of: adjusting and outputting the mixed audio signal.

23. The method according to claim 22, wherein the adjustment includes adjusting voice frequency of the mixed audio signal.

24. The method according to claim 22, wherein the adjustment includes adjusting voice waveform of the mixed audio signal.

25. The method according to claim 22, wherein the adjustment includes adjusting voice volume of the mixed audio signal.
